(19) United States
(12) Patent Application Publication
(10) Pub. No.: US 2008/0026896 A1
(43) Pub. Date: Jan. 31, 2008

(54) Bicycle chain with connected outer plates

(76) Inventor: Sean Curran, Clifton, NJ (US)

Correspondence Address: Christine W. Trebilcock;Cohen & Grigsby, P.C., 15th Floor, 11 Stanwix Street, Pittsburgh, PA, 15222-1319, US

(21) Appl. No.: 11/493,873

(22) Filed: Jul. 26, 2006

(51) Int. Cl. F16G 13/02

(52) U.S. Cl. 474/206

(57) ABSTRACT

The invention is a chain unit comprising first and second link units, a unitary outer plate, and first and second pins. Each link unit comprises two inner plates with two rollers positioned therebetween. The outer plate straddles and is secured to the link units. Outer plate comprises two walls and a bridge positioned therebetween that spans the tooth engaging space between link units. The unitary construction of the outer plate provides a structural integrity that prevents the plates from separating when the chain is exposed to force. A plurality of chain units can be linked together to form a chain.

### FIELD OF INVENTION

The invention relates to chain units and particularly to chain units having a unitary outer plate.

### BACKGROUND OF INVENTION

Standard bicycle chains are primarily designed to transfer and handle drive loads to the back wheel. While the traditional design works well to transfer loads, one shortcoming of the chains known in the art is that the chains become weak when they are exposed to excessive forces. However, modern bicycles are often used in environments where the chain comes into contact with objects in the environment at various angles and speeds, thereby subjecting the chain to excessive forces. If an object contacts the chain at an angle that is not in line with the drive direction, the outer plates of the chain can bend and pull from the pin. This causes the chain to break from the impact or to weaken to a point that it fails when a drive load is placed upon it. Such damage endangers the rider. Bicycle chains known in the art have tried to address the problem in different ways, such as by using larger and thicker plates and/or riveted pins. While using a larger chain and plates may strengthen the chain so that it can withstand impacts, these larger chains can weigh up to a pound or more. The added weight is inefficient because it can impact the rider's performance. Further, often times these larger chains do not fit well on sprockets. In some instances, larger chains do not fit on the sprocket at all. In fact, in recent years, sprockets have become smaller (i.e., they have fewer teeth), and as a result, large chains cannot make the tight bends. Further, even when the larger chains do fit on the sprocket, the larger chains tend to wear the sprocket teeth down faster, thereby reducing the lifespan of the sprocket teeth. Thus, there is a need for a bicycle chain that can both withstand impacts and function in an effective and efficient manner.

### SUMMARY OF INVENTION

The present invention meets this need by providing a chain unit that is strong enough to withstand impacts with objects that are encountered in the environment and that is sized to work efficiently in the chain unit.

It is therefore an object of the claimed invention to provide a chain unit that is strong enough to withstand impacts from objects encountered during use.

It is another object of the claimed invention to provide a chain unit that has an outer plate that is strong enough to resist bending or breaking when it is impacted by foreign objects.

It is still a further object of the claimed invention to provide a chain unit that has a unitary outer plate.

It is still a further object of the claimed invention to provide an outer plate that can be retrofitted to connect to the inner plates of a conventional chain.

It is another object of the claimed invention to provide a chain made of a plurality of chain units having unitary outer plates.

It is yet another object of the claimed invention to provide an outer plate that is substituted for the conventional outer plate on a conventional chain.

In an embodiment, the claimed invention is a chain unit comprising first and second link units, a unitary outer plate, and first and second pins. Each link unit comprises two inner plates positioned in a first plane and being substantially parallel to each other. The inner plates are separated by a first distance. Each inner plate has first and second holes that substantially align with first and second holes in the other inner plate. There are two rollers positioned in the space between the inner plates of each link unit. Rollers are separated from each other by a first tooth engaging space. One roller has a hole that substantially aligns with first holes in the inner plates and the other roller has a hole that substantially aligns with second holes in the inner plates. The unitary outer plate straddles the second end region of the first link unit and the first end region of the second link unit. The outer plate comprises two walls and a bridge. The walls are positioned in the first plane, are separated by a second distance, and are substantially parallel to each other and to the inner plates. A second surface of one wall opposes the first surface of one inner plate and the second surface of the other wall opposes the first surface of the other inner plate. First holes in each wall substantially align with second holes of inner plates of first link unit and second holes in each wall substantially align with first holes of inner plates of second link unit. The bridge of the outer plate is positioned in a second plane and between the two walls. Second plane is substantially perpendicular to the first plane. The bridge substantially spans second tooth engaging space. Outer plate is secured to first link unit by a first pin and to second link unit by a second pin. The unitary outer plate construction provides a structural integrity that prevents the outer plate from pulling apart from the inner plates when a force is applied to the chain unit in a direction that is not parallel to the drive direction.

Another embodiment is for a unitary outer plate for use with a chain.

Another embodiment is for a chain comprised of a plurality of chain units that may optionally be combined with a bicycle.

Those and other details, objects, and advantages of the present invention will become better understood or apparent from the following description and drawings showing embodiments thereof.

### BRIEF DESCRIPTION OF THE DRAWINGS

The accompanying drawings illustrate examples of embodiments of the invention. In such drawings:

FIG. 1A shows a top view of an example of an embodiment of the claimed unitary outer plate, FIG. 1B shows a side view of an example of an embodiment of the claimed unitary outer plate, and FIG. 1C shows an end view of an example of an embodiment of the claimed unitary outer plate.

FIG. 2 shows an isometric view of an example of an embodiment of the claimed unitary outer plate.

FIG. 3 shows an isometric view of an example of an embodiment of the claimed chain unit.

FIG. 4 shows a side view of an example of an embodiment of the claimed chain in combination with a sprocket.

### DETAILED DESCRIPTION OF INVENTION

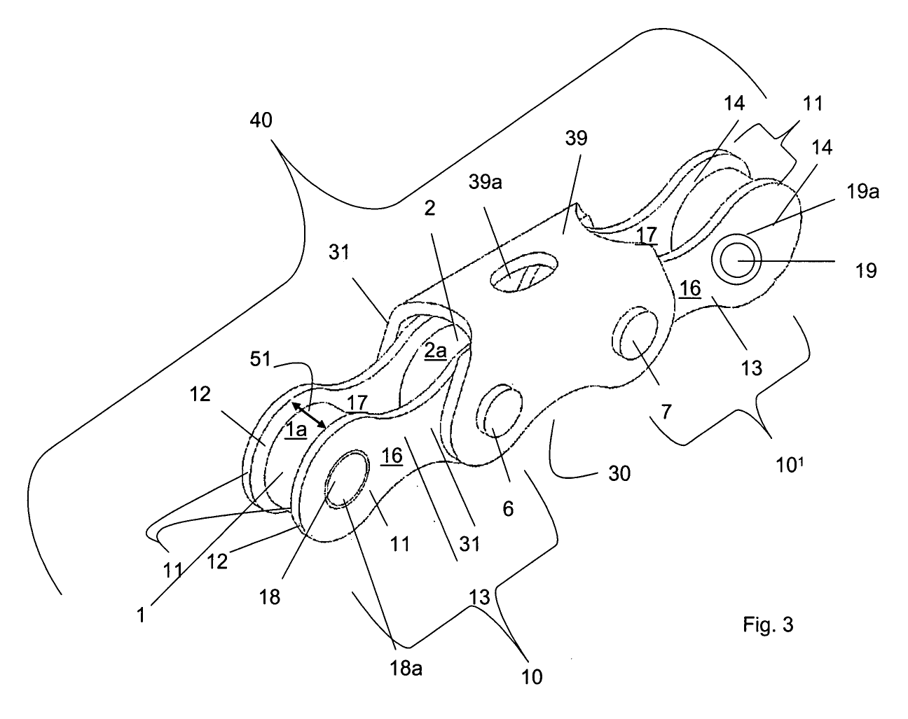

FIG. 3 shows an isometric view of an example of an embodiment of the claimed chain unit 40. In an embodiment, each chain unit 40 comprises two link units 10, 10′, a unitary outer plate 30, and first 6 and second 7 pins. Each link unit 10, 10′ comprises two inner plates 11, 11 and first 1 and second 2 rollers. Inner plates 11, 11 are made of steel or titanium. Inner plates 11, 11 are positioned substantially parallel to each other in first plane and are separated by a distance 51 therebetween. In an example, distance 51 is about 0.105-0.145 inches and is preferably about 0.125 inch (⅛ inch). In another example, distance 51 is about 0.074 to about 0.114 inch, and is preferably about 0.09375 inch ( 3/32 inch). Inner plates 11, 11 have first 16 and second 17 surfaces and first 18 and second 19 holes, respectively. Second surfaces 17 of the two inner 11, 11 plates of one link unit are opposed to each other. Each inner plate 11, 11 has first 12 and second 14 end regions and a solid middle region 13. In an example, end regions 12, 14 have substantially equal heights and are larger than the height of middle region 13. In other examples, the shape and size of inner plates, 11, 11 is varied. First hole 18 is located in first 12 end region of each inner plate 11 and second hole 19 is located in second end region 14. Holes 18, 19 are sized such that pins 6, 7, described in more detail below, fit therein and extend there through. In an example, a bushing (not shown) is positioned in each of first 18 and second 19 holes. In an example, pins 6, 7 have diameters of about 2.5 to about 4.4 mm, and preferably about 3.5 mm. In other examples, an inner edge of each hole 18, 19 has an outwardly extending lip 18a, 19a on which pin 6, 7 rests. To allow for easy rotation, holes 18, 19 have diameters of about 2.6 to about 4.5 mm, and preferably about 3.55 to about 3.66 mm.

Each link unit 10, 10′ further comprises first 1 and second 2 rollers or axles positioned between inner plates 11, 11. In examples, rollers 1, 2 have a diameter of about 5.6 to about 9.4 mm, and preferably about 7.55 mm. First roller 1 has a hole (not shown) that substantially aligns with first holes 18, 18 in inner plates 11, 11 and second roller 2 has a hole (not shown) that substantially aligns with second holes 19, 19 in inner plates 11, 11 of each link unit. There is a first tooth engaging space 53 between rollers 1, 2. Preferably, there is a distance of about 0.4 inch to about 0.6 inch from center of roller 1 to center of roller 2. Rollers 1, 2 each have a contacting surface 1a, 2a that contacts teeth 41 of sprocket 42 (described below) and that rotates in drive direction D.

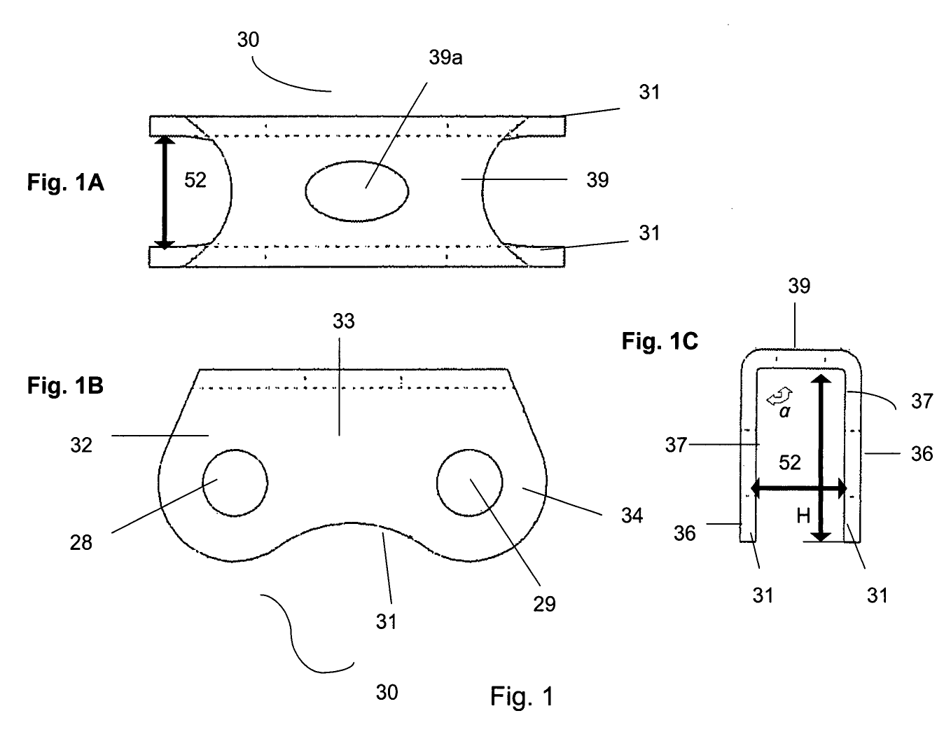

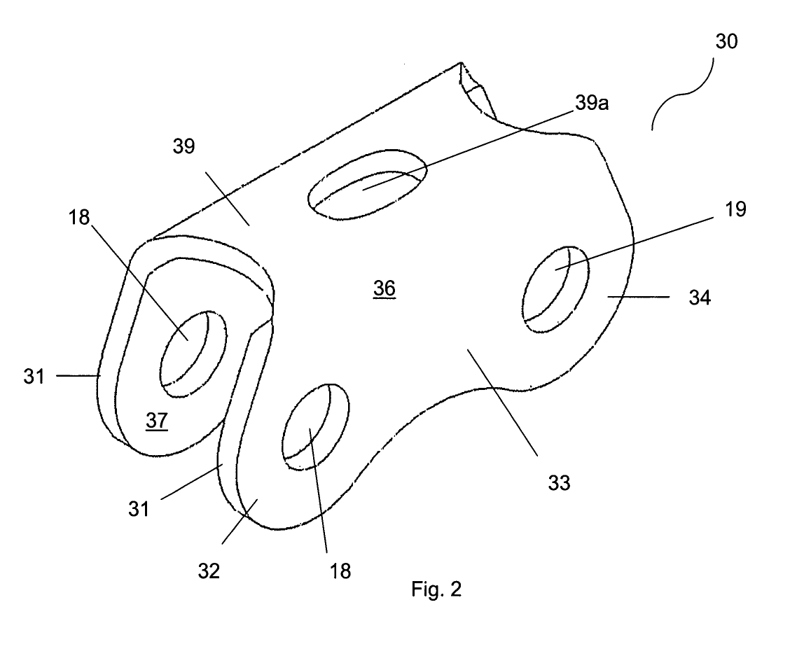

The claimed chain unit 40 further comprises a unitary outer plate 30 shown in the figures, and particularly in FIGS. 1 and 2. In an example, unitary outer plate 30 is an inverted U-shaped member. In examples, outer plate 30 is made of steel or titanium. In an example, unitary outer plate 30 is made of the same material from which inner plates 11, 11 are made. In another example, outer plate 30 is made of a different material from which inner plates 11, 11 are made. Unitary outer plate 30 comprises two walls 31 and a bridge 39 positioned therebetween. Walls 31, 31 each have first 36 and second 37 surfaces.

Walls 31, 31 are positioned substantially parallel to inner plates 11, 11 in first plane. Walls 11, 11 define a second space 52 therebetween. Second space 52 is slightly larger than first space 51. Second space 52 is preferably wide enough for inner plates 11, 11, bushings, and rollers 1, 2 to fit between walls 31, 31. Inner plates 11, 11 slide and rotate freely on pins 6, 7 such that their position between walls 31, 31 of outer plate 30 is not fixed. In an example, distance of second space 52 is such that second surface 37 of wall 31 does not touch first surface 16 of inner plate 11. In another example, second surface 37 of at least one wall 31 does contact first surface 16 of at least one inner plate 11.

Walls 31, 31 have a size and shape that is substantially complementary to a size and shape of inner plates 11, 11. As described above in regards to inner plates 11, 11, each wall 31, 31 has first 32 and second 34 end regions and a middle region 33.

Each outer plate 30 of a chain unit straddles two link units 10, 10′. As shown in FIG. 3, first end region 32 straddles second end region 14 of first link unit 10 and second end region 34 straddles first end regions 12, 12 of the second link unit 10′. Second surface 37 of one wall 31 opposes first surface 16 of one inner plate 11 and second surface 37 of the other wall 31 opposes first surface 16 of other inner plate 11.

Each wall 31 has first 18 and second 19 holes that are preferably located near first 32 and second 34 end regions of each wall 31, 31, respectively. In an example, pins 6, 7 fit snugly in holes 18, 19. In an example, holes 18, 19 have diameters of about 2.45 to about 4.45 depending on pin 6, 7 diameter. First hole 18, 18 substantially align with second hole 19, 19 in first inner plates 11, 11 of first link unit 10 and second holes 19, 19 substantially align with first holes 18, 18 in first inner plates 11, 11 of second link unit 10′.

Unitary outer plate 30 further comprises a bridge 39, as shown particularly in FIGS. 1-3. Bridge 39 is positioned between walls 31, 31 in a second plane that is substantially perpendicular to first plane. Bridge 39 substantially spans second tooth engaging space 54. Preferably, walls 31, 31 and bridge 39 intersect at an angle α that is about 67° to about 113°, and preferably about 90°. Walls 31, 31 have a height H that is high enough to allow for clearance of inner plates 11, 11 such that walls 31, 31 substantially cover inner plates 11, 11. Bridge 39 may be a solid piece of material (not shown) or may optionally have at least one hole 39a to reduce weight. Further, end pieces of bridge may be substantially straight (not shown) or may optionally be trimmed to reduce weight of bridge 39. Thus the structure defined by the bridge and walls comprises an inverted U-shaped base member.

Outer plate 30 is secured to inner plates 11, 11 by first 6 and second 7 pins that extend through holes 18, 19 at a substantially constant pitch of about 0.4 to about 0.6 mm. In an example, first pin 6 extends through first hole 28 in one of walls 31, second hole 19 in one of inner plates 11 of first link unit 10, hole in second roller 2 of first link unit 10, second hole 19 in the other inner plate 11, and first hole 28 in the other wall 31. Second pin 7 extends through second hole 29 in one of walls 31, first hole 18 in one inner plates 11 of second link unit 10′, hole in first roller 1 of second link unit 10′, first hole 18 in the other inner plate 11, and second hole 29 in the other wall 31. Optionally, there is a bushing (not shown) positioned in each of first 18 and second 19 holes in inner plates 11, 11.

In another embodiment, the claimed invention is a unitary outer plate 30 for use with a chain 100. As described above, the unitary outer plate 30 comprises first and second two walls 31, 31 and a bridge 39 and is capable of straddling and being secured to two link units 10, 10′ of a chain. In an example, each inner plate 11, 11 of the link unit 10 to which outer plate is being attached or secured has two holes 18, 19 that substantially align with holes 28, 29, respectively, in walls 31, 31 of outer plate 30, as described above. First end region 32 of outer plate 30 is secured to second end region 14 of first link unit and second end 34 region of outer plate 30 is secured to first end region 12 of second link unit 10′. In an example, outer plate 30 is secured to link units 10, 10′ by pins 6, 7 as described above.

In an example, unitary outer plate 30 can be connected to inner plates 11, 11 of a conventional chain to replace conventional two-piece outer plates (not shown).

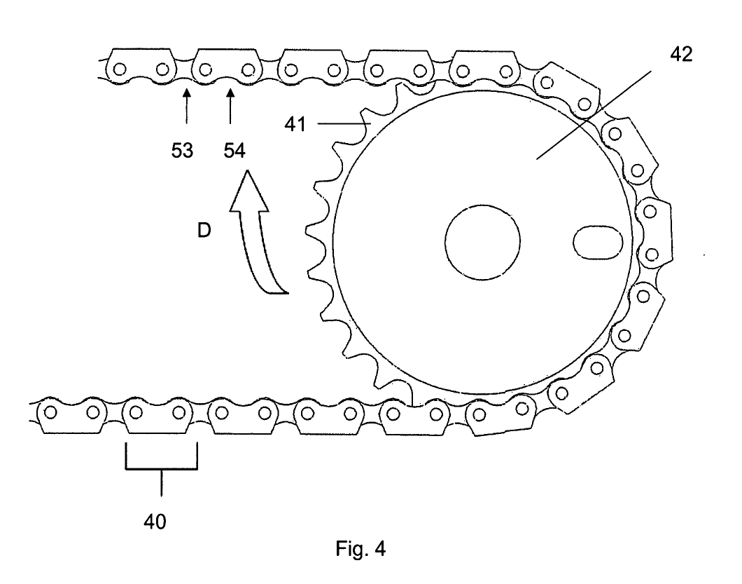

In another embodiment, the claimed invention is a chain 100 comprised of a plurality of chain units 40 described above. Each chain unit 40 comprises two link units, another plate, and two pins as described above. Chain 100 is assembled by linking together a plurality of chain units as described above. As shown in FIG. 4, first end region 12 of each link unit 10, 10′ will have secured thereto a second end region 34 of an outer plate 30 and second end region 14 of each link unit 10, 10′ will have secured thereto a first end region 32 of an outer plate 30 to form a continuous chain.

In an example, the chain 100 comprising a plurality of chain units 40 is combined with a bicycle (not shown). Drive sprocket 42 is rotated by the rider. As sprocket 42 is rotated, chain 100 is driven around sprocket 42, causing secondary sprocket (not shown) affixed to rear wheel (not shown) to also rotate. As chain 100 rotates contacting surfaces 1a, 2a of rollers 1, 2, respectively, come into contact with and are engaged by sprocket teeth 41 to rotate roller 1, 2 about pin 6, 7. The forces of the sprocket teeth 41 on the rollers 1, 2 are transferred to pins 6, 7 and then to inner 11, 11 and outer 30 plates. This is repeated through each chain unit 40.

While the foregoing has been set forth in considerable detail, it is to be understood that the drawings and detailed embodiments are presented for elucidation and not limitation. Design variations, especially in matters of shape, size, and arrangements of parts, may be made but are within the principles of the invention. Those skilled in the art will realize that such changes or modifications of the invention or combinations of elements, variations, equivalents, or improvements therein are still within the scope of the invention as defined in the appended claims.

I claim:

1. A chain unit, comprising:
a. first and second link units, each link unit comprising:
i. two inner plates positioned substantially parallel to each other in a first plane, each said inner plate having first and second surfaces and first and second holes, said second surfaces of said inner plates being opposed and said first and second holes of each said inner plate being substantially aligned with said first and second holes of said other inner plate, respectively; and
ii. two rollers positioned between said inner plates and being separated from each other by a first tooth engaging space, one of said rollers having a hole that substantially aligns with said first holes in said inner plates and the other of said rollers having a hole that substantially aligns with said second holes in said inner plates;
b. a unitary outer plate that straddles a second end region of said first link unit and a first end region of said second link unit, there being a second tooth engaging space between said second roller of said first link unit and said first roller of said second link unit, said unitary outer plate comprising:
i. two walls positioned in said first plane and being substantially parallel to each other and to said inner plates, each of said walls having first and second surfaces and first and second holes, said second surface of one of said walls opposing said first surface of one of said inner plates of each link unit and said second surface of the other of said walls opposing said first surface of the other of said inner plates of each link unit, said first holes substantially aligning with said second holes of said inner plates of said first link unit and said second holes substantially aligning with said first holes of said inner plates of said second link unit; and
ii. a bridge positioned between said two walls in a second plane, said second plane being substantially perpendicular to said first plane and said bridge substantially spanning said second distance and said second tooth engaging space;
c. a first pin that secures said outer plate to said first link unit; and
d. a second pin that secures said outer plate to said second link unit.

2. A chain unit as in claim 1 wherein a bushing is positioned in each of said first and second holes in each of said inner plates.

3. A chain unit as in claim 1 wherein said first pin passes through said first holes in said first and second walls, said second holes in said inner plates of said first link unit, and said hole in said second roller of said first link unit.

4. A chain unit as in claim 1 wherein said second pin passes through said second holes in said first and second walls, said first holes in inner plates of said second link unit, and said hole in said first roller of said second link unit.

5. An unitary outer plate for use with a chain, said outer plate comprising:
a. a first wall positioned in a first plane and having first and second holes and first and second surfaces;
b. a second wall positioned substantially parallel to said first wall in said first plane and having first and second holes and first and second surfaces, said first and second holes of said second wall being substantially aligned with said first and second holes of said first wall, respectively, there being a second distance between said first and second walls; and
c. a bridge positioned in a second plane between said first and second walls, said second plane being substantially perpendicular to said first plane, said bridge substantially covering said second distance between said walls, wherein said unitary outer plate is capable of straddling and being secured to at least one link unit of a chain.

6. An outer plate as in claim 5 wherein each said link unit has a plurality of holes that substantially align with said holes in said walls of said outer plate.

7. An outer plate as in claim 6 wherein a pin extends through said substantially aligned holes to secure said unitary outer plate to said at least one link unit.

8. A chain comprised of a plurality of chain units, each said chain unit comprising:
a. two link units, each link unit having first and second end regions and comprising:
i. two inner plates positioned substantially parallel to each other in a first plane, each said plate having first and second surfaces and first and second holes, said first and second holes in one of said inner plates being substantially aligned with said first and second holes, respectively, in the other of said inner plates; and
ii. first and second rollers positioned between said inner plates, said first roller having a hole that substantially aligns with said first holes in each of said inner plates and said second roller having a hole that substantially aligns with said hole in each of said inner plates;
b. a unitary outer plate that is capable of straddling a second end region of a first link unit and a first end region of a second link unit, each unitary outer plate comprising:
i. two walls positioned substantially parallel to said inner plates in said first plane, each said wall having first and second surfaces and first and second holes, said first holes substantially aligning with said second holes in said inner plates of said first link unit and said second holes substantially aligning with said first holes in said inner plates of said second link unit; and
ii. a bridge positioned in a second plane between said first and second walls, said second plane being substantially perpendicular to said first plane;
c. a first pin that secures said outer plate to said first link unit; and
d. a second pin that secures said outer plate to said second link unit.

9. The chain of claim 8 wherein a contacting surface of at least one of said rollers is engaged by a tooth of a sprocket to rotate said roller about said pin

10. A chain unit as in claim 8 wherein a bushing is positioned in each of said first and second holes in each of said inner plates such that said pin engages a surface of said bushing as said roller rotates.

11. A chain as in claim 8, wherein said chain is combined with a bicycle.

12. In a chain having multiple link units in which each link unit comprises two parallel inner plates joined together at first and second ends by first and second rollers each having an axle that is mounted to respective first and second holes at said ends of said plates, said rollers being spaced apart a distance to accommodate a sprocket tooth, the improvement therein being a protective bridge comprising an inverted U-shaped base joining first and second link units of said chain and having first holes adjacent said second holes of said inner plates of a first link unit and second holes adjacent said first holes of said second inner plates of the next adjacent link unit, a pair of pins, one of each said pair spanning one of said axles and said openings in said inverted U-shaped base and said other of said pair spanning said other axles and holes in said inverted base.
